(19) United States
(12) Patent Application Publication
(10) Pub. No.: US 2020/0063223 A1
(43) Pub. Date: Feb. 27, 2020

(54) Sterilizing and soaking device for leather manufacturing

(71) Applicant: Huiting Ye, Guangzhou City (CN)

(72) Inventor: Huiting Ye, Guangzhou City (CN)

(21) Appl. No.: 16/673,966

(22) Filed: Nov. 5, 2019

(30) Foreign Application Priority Data
Jun. 20, 2019 (CN) 2019105385874

(51) Int. Cl. C14C 1/04; C14C 15/00

(52) U.S. Cl. CPC C14C 1/04; C14C 15/00

(57) ABSTRACT

A sterilizing and soaking device for leather manufacturing includes a disinfecting machine (11), a soaking cavity (12) is formed in the disinfecting machine (11), the upper side of the soaking cavity (12) is communicated with an accommodating cavity (13) which penetrates left and right and is upward in opening, a rotating device (101) is arranged in the soaking cavity (12). The cow leather can be better contacted with the disinfectant, the cow leather can be automatically driven to rotate, the disinfection efficiency is increased, the water flow generated by rotation can be used for stirring the disinfectant, so that the disinfectant is uniformly mixed, and the disinfection effect is enhanced.

### FIELD OF THE INVENTION

The present invention relates to a sterilizing and soaking device for leather manufacturing.

### BACKGROUND OF THE INVENTION

Before the leather is made into leather, it needs to be disinfected before subsequent production and processing. Most of them are disinfected by soaking in disinfectant, and the soaking time is long. The existing soaking and disinfecting devices need to stack up the cowhide, so the disinfection effect of the cowhide below and in the middle is not good, and in the long-term soaking process, the disinfection components in the disinfectant will be distributed unevenly, resulting in layered phenomenon, resulting in inconsistent disinfection of the cowhide in the upper and lower layers. The invention discloses a device capable of solving the above problems.

### SUMMARY OF THE INVENTION

Technical Issues:

The common cattle hide disinfection and soaking device needs manual operation to remove the cattle hide from the disinfectant, and the cattle hide is stacked in the disinfectant, so the disinfection contact is insufficient.

The invention aims to solve the problem, and discloses a sterilizing and soaking device for leather manufacturing, which comprises a sterilizer, wherein a soaking cavity is formed in the disinfecting machine, wherein the upper side of the soaking cavity is communicated with the upper side of the soaking cavity; the upper side of the soaking cavity is communicated with a left-right penetrating and upward-upward placing cavity, wherein a rotating device is arranged in the soaking cavity, and the rotating device can soak the cow leather in the soaking cavity, and the cow leather is rotated at a constant speed, and the disinfectant is stirred, and meanwhile, the contact area of the cow leather and the disinfectant can be increased, so that the cow leather can be better disinfected, and a lifting device is symmetrically arranged on the front side and the rear side of the soaking cavity, the falling device can automatically drive the rotating device to ascend and descend, so that workers can conveniently place the cow leather., turning plate devices are arranged on the front side and the rear side of the rotating device, when the falling device drives the rotating device to enter the placing cavity, so that the cow leather falls into the soaking cavity; a switching device is arranged on the left side of the descending device on the left side; when the rotating device is positioned in the soaking cavity, the rotating device can be automatically rotated; when the rotating device is positioned in the placing cavity, the rotating device can be rotated manually, so that the cow leather can be conveniently placed.

The preparation method comprises the following steps: wherein the rotating device comprises a lifting plate which is symmetrically arranged in the soaking cavity in a left-and-right manner, a rotating belt is wound between the rollers; a rotating shaft is fixedly arranged at the axis of the roller; a belt wheel cavity is arranged in the lifting plate on the left side; a driven belt wheel is fixedly arranged in the belt wheel cavity; a driving belt wheel is rotationally arranged on the upper side between the driven belt wheels; a transmission belt is wound between the driving belt wheel and the driven belt wheel.

A lifting rod is slidably arranged in the lifting cavity; a threaded cavity with downward opening is formed in the lifting rod; a threaded rod rotationally connected to the lower wall of the lifting cavity is in threaded connection in the threaded cavity; a bevel gear cavity is formed in the lower side of the lifting cavity; a driven bevel gear is fixedly arranged in the bevel gear cavity at the lower end of the bevel gear cavity.

Wherein a lifting motor is fixedly arranged in the inner wall between the bevel gear cavities; the left end and the right end of the lifting motor are symmetrically and electrically connected with a power shaft; the opposite end of the power shaft extends into the bevel gear cavity and is fixedly provided with a driving bevel gear meshed with the driven bevel gear.

A guide sliding rod which is fixedly connected to the upper end of the lifting rod is slidably arranged in the guide sliding cavity; the relative end of the guide sliding rod is fixedly connected to the lifting plate.

The preparation method comprises the following steps: the turnover plate device comprises a turnover plate which is bilaterally symmetric and can be overturned and arranged in the discharge cavity, a rotating shaft is fixedly arranged at the rotating center of the upper end of the turning plate; a straight gear is fixedly arranged at the left end and the right end of the turning shaft; a straight gear is fixedly arranged in the lifting cavity; a fixing rod is symmetrically and fixedly arranged at the front end and the rear end of the lifting rod; a rack which can be meshed with the straight gear is fixedly arranged at one end, far away from the lifting rod, of the fixing rod.

The preparation method comprises the following steps: the switching device comprises a power cavity which is communicated with the left wall of the lifting cavity on the left side, and a rotating motor is fixedly arranged at the lower end of the left wall of the power cavity, the right end of the rotating motor is in power connection with a driving straight gear, a transmission spur gear which can be meshed with the driving spur gear is rotationally arranged at the left end of the guide sliding rod on the left side; a transmission shaft is fixedly arranged at the axis of the transmission straight gear; the right end of the transmission shaft is fixedly connected with the axis of the driving belt wheel; a manual straight gear capable of being meshed with the transmission straight gear is rotationally arranged on the upper side in the power cavity; a manual shaft is fixedly arranged at the axis of the manual straight gear; a rocker is fixedly arranged at the left end of the manual shaft to the outside.

Preferably, when the transmission spur gear is meshed with the rotation motor, the rotation motor provides power, and when the transmission spur gear is meshed with the manual spur gear, the rocker provides power for the rocker.

The device disclosed by the invention has the beneficial effects that the cow leather can be better contacted with the disinfectant, the cow leather can be automatically driven to rotate, the disinfection efficiency is increased, the water flow generated by rotation can be used for stirring the disinfectant, so that the disinfectant is uniformly mixed, and the disinfection effect is enhanced.

### BRIEF DESCRIPTION OF THE DRAWINGS

For better explaining the technical proposal in the present invention embodiments or the prior art, the drawings to be used in the description of the embodiments or the prior art will be briefly described below.

FIG. 1 is an overall structural diagram of the present invention;

FIG. 2 is the schematic structural diagram along “A-A” direction in FIG. 1;

FIG. 3 is the schematic structural diagram along “B-B” direction in FIG. 1;

FIG. 4 is the schematic structural diagram along “C-C” direction in FIG. 1;

FIG. 5 is the schematic structural diagram along “D-D” direction in FIG. 1.

### DETAILED DESCRIPTION OF THE INVENTION

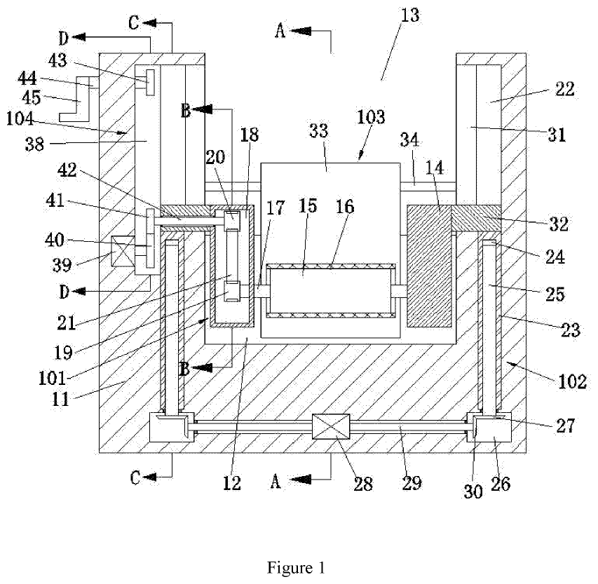

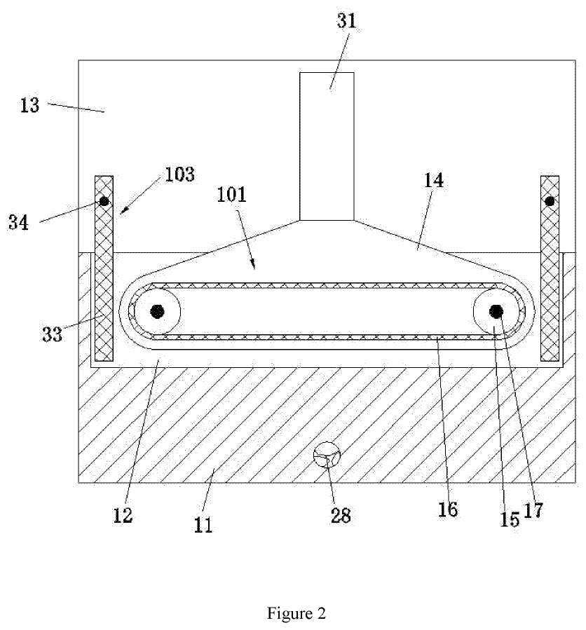

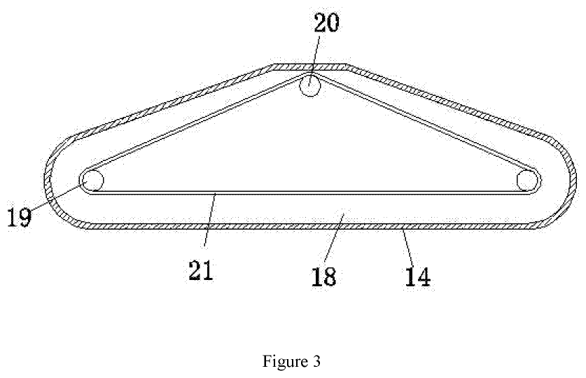

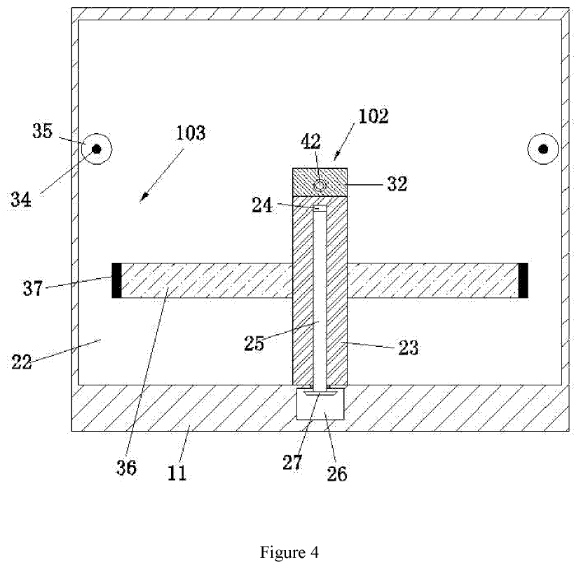

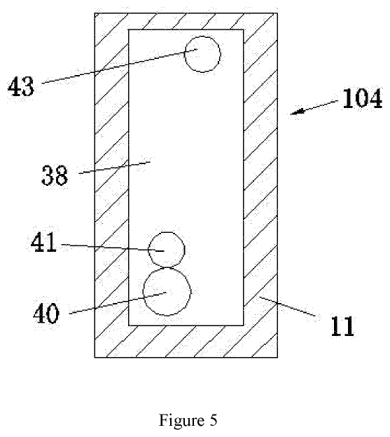

The invention will be described in detail below referring to FIGS. 1-5. For better explanation, the orientations described hereinafter are defined as follows: directions of up, down, left, right, front and rear in the text are identical to the directions of up, down, left, right, front and rear of FIG. 1.

The invention relates to a sterilizing and soaking device for leather manufacturing, which is mainly applied to disinfection work of cow leather in the leather manufacturing process, and further comprises the following steps:

The sterilizing and soaking device for leather manufacturing is provided., which comprises a disinfecting machine 11, a soaking cavity 12 is formed in the disinfecting machine 11, the upper side of the soaking cavity 12 is communicated with an accommodating cavity 13 which penetrates left and right and is upward in opening, a rotating device 101 is arranged in the soaking cavity 12, the rotating device 101 can soak the cow leather in the soaking cavity 12, and the cow leather is rotated at a constant speed, and the disinfectant is stirred, and meanwhile, the contact area of the cow leather and the disinfectant can be increased., so that the cow leather can be better disinfected., and a lifting device 102 is symmetrically arranged on the front side and the rear side of the soaking cavity 12, the falling device 102 can automatically drive the rotating device 101 to ascend and descend, so that workers can conveniently place the cow leather., and a turning plate device 103 is arranged on the front side and the rear side of the rotating device 101, when the descending device 102 drives the rotating device 101 to enter the placing cavity 13, so as to drive the turning plate device 103 to turn over to the lower side of the rotating device 101, the left side of the descending device 102 on the left side is provided with a switching device 104; when the rotating device 101 is positioned in the soaking cavity 12, the rotating device 101 can be automatically rotated; when the rotating device 101 is positioned in the placing cavity 13, the rotating device 101 can be rotated manually, so that the cow leather can be conveniently placed.

According to an embodiment, the rotating device 101 is described in detail below., the rotating device 101 comprises a lifting plate 14 which is symmetrically arranged in the soaking cavity 12 in a left-right symmetry mode, and a roller 15 is rotationally connected to the left side and the right side of the lifting plate 14, a rotating shaft 17 is fixedly arranged at the axis of the roller 15, a belt wheel cavity 18 is arranged in the lifting plate 14 on the left side, a driven belt wheel 19 is fixedly arranged in the belt wheel cavity 18 at the left end of the rotating shaft 17, a driving belt wheel 20 is rotatably arranged on the upper side between the driven belt wheel 19, and a transmission belt 21 is wound between the driving belt wheel 20 and the driven belt wheel 19.

According to an embodiment, the falling device 102 is described in detail below., the falling device 102 comprises a lifting cavity 22 which is symmetrically arranged on the left side and the right side of the placing cavity 13, a threaded cavity 24 with a downward opening is formed in the lifting rod 23, a threaded rod 25 connected to the lower wall of the lifting cavity 22 is in threaded connection in the threaded cavity 24, a bevel gear cavity 26 is formed in the lower side of the lifting cavity 22, and a driven bevel gear 27 extends into the bevel gear cavity 26 through the lower end of the bevel gear cavity 26.

A lifting motor 28 is fixedly arranged in the inner wall between the bevel gear cavities 26, the left end and the right end of the lifting motor 28 are symmetrical and are connected with a power shaft 29 in a power mode, and the opposite end of the power shaft 29 extends into the bevel gear cavity 26 and is fixedly provided with a driving bevel gear 30 meshed with the driven bevel gear 27.

A guide sliding cavity 31 is communicated between the lifting cavity 22 and the placing cavity 13, a guide sliding rod 32 fixedly connected to the upper end of the lifting rod 23 is slidably arranged in the guide sliding cavity 31, and the relative end of the guide sliding rod 32 is fixedly connected to the lifting plate 14.

According to an embodiment, the turning plate device 103 is described in detail below., the turnover plate device 103 comprises a turnover plate 33 which is bilaterally symmetric and can be overturned and arranged in the placing cavity 13, a rotating shaft 34 is fixedly arranged at the rotating center of the upper end of the turning plate 33, a straight gear 35 is fixedly arranged at the left end and the right end of the turning shaft 34, a straight gear 35 is fixedly arranged in the lifting cavity 22, a fixing rod 36 is symmetrically and fixedly arranged at the front end and the rear end of the lifting rod 23, and a rack 37 which can be meshed with the straight gear 35 is fixedly arranged at one end, away from the lifting rod 23, of the fixing rod 36.

According to an embodiment, the switching device 104 is described in detail below., the switching device 104 comprises a power cavity 38 which is communicated with the left wall of the lifting cavity 22 arranged on the left side, a rotating motor 39 is fixedly arranged at the lower end of the left wall of the power cavity 38, the right end of the rotating motor 39 is in power connection with a driving straight gear 40, and a transmission spur gear 41 which can be meshed with the driving spur gear 40 is rotatably arranged at the left end of the guide sliding rod 32 on the left side, a transmission shaft 42 is fixedly arranged at the axis of the transmission spur gear 41, the right end of the transmission shaft 42 is fixedly connected to the axis of the driving belt wheel 20, a manual spur gear 43 capable of being meshed with the transmission spur gear 41 is rotationally arranged on the upper side of the power cavity 38, a manual shaft 44 is fixedly arranged on the axis of the manual spur gear 43, and a rocker rod 45 extends to the outside of the left end of the manual shaft 44.

Advantageously, when the transmission spur gear 41 is engaged with the rotation motor 39, the rotation motor 39 provides power, and when the transmission spur gear 41 is engaged with the manual spur gear 43, the rocker arm 45 provides power.

The use steps of the sterilizing and soaking device for leather manufacturing are described in detail below with reference to FIGS. 1-5.

In the vertical state; the roller 15 and the rotating belt 16 are positioned in the soaking cavity 12; the lifting rod 23 is positioned at the lower limit position; the transmission straight gear 41 is meshed with the driving straight gear 40.

When the cow leather is placed, the lifting motor 28 is started, and drives the driving bevel gear 30 to rotate through the power shaft 29, the driven bevel gear 27 is driven to rotate through the gear meshing, and the screw 25 is driven to rotate, and the lifting rod 23 is driven to ascend through the threaded connection, and the lifting plate 14 is driven by the guide sliding rod 32, a roller 15 and a rotating belt 16, at the moment, the lifting rod 23 drives the rack 37 to rise through the fixing rod 36, when the rotating belt 16 is completely lifted above the turning shaft 34, and the rack 37 is meshed with the straight gear 35, the lifting rod 23 continues to go up to the transmission spur gear 41 to be meshed with the manual spur gear 43, and the gear rack 37 rises and is meshed with the gear to drive the straight gear 35 to rotate, and the turnover plate 33 is driven by the turnover shaft 34 to be overturned to the lower part of the rotating belt 16 and is in a horizontal state, and the cow leather is fixed on the outer surface of the rotating belt 16 through a clamp, a manual rotary rocker rod 45, the driving belt wheel 20 is driven to rotate through the transmission shaft 42, the driven belt wheel 19 is driven to rotate through the transmission belt 21, the roller 15 is driven to rotate through the rotating shaft 17 and drive the rotating belt 16 to rotate, the rotating belt 16 does not stick to the position above or below the cow leather, the lifting motor 28 rotates reversely, the device is restored to the initial state, and the cow leather is soaked in the disinfectant.

The rotating motor 39 is started and drives the driving straight gear 40 to rotate, the transmission spur gear 41 is driven to rotate through the gear engagement, the rotating belt 16 is driven to rotate, the cow leather is soaked in the disinfectant for rotation, the disinfectant is stirred to a certain extent, the rotating motor 39 can be regularly arranged, the rotating motor 39 can be started at regular time and rotated and disinfected.

The device disclosed by the invention has the beneficial effects that the cow leather can be better contacted with the disinfectant, the cow leather can be automatically driven to rotate, the disinfection efficiency is increased, the water flow generated by rotation can be used for stirring the disinfectant, so that the disinfectant is uniformly mixed, and the disinfection effect is enhanced.

According to the mode, persons skilled in the art can make various changes according to the working modes within the scope of the invention.

1. A sterilizing and soaking device for leather manufacturing, comprises:
a sterilizer,
wherein a soaking cavity is formed in the disinfecting machine, wherein the upper side of the soaking cavity is communicated with the upper side of the soaking cavity;
the upper side of the soaking cavity is communicated with a left-right penetrating and upward-upward placing cavity,
wherein a rotating device is arranged in the soaking cavity,
and the rotating device can soak the cow leather in the soaking cavity,
and the cow leather is rotated at a constant speed, and the disinfectant is stirred,
and meanwhile, the contact area of the cow leather and the disinfectant can be increased, so that the cow leather can be better disinfected,
and a lifting device is symmetrically arranged on the front side and the rear side of the soaking cavity, the falling device can automatically drive the rotating device to ascend and descend, so that workers can conveniently place the cow leather,
turning plate devices are arranged on the front side and the rear side of the rotating device, when the falling device drives the rotating device to enter the placing cavity, so that the cow leather falls into the soaking cavity;
a switching device is arranged on the left side of the descending device on the left side.

2. The sterilizing and soaking device for leather manufacturing as defined in claim 1, wherein the rotating device comprises a lifting plate which is symmetrically arranged in the soaking cavity in a left-and-right manner,
a rotating belt is wound between the rollers;
a rotating shaft is fixedly arranged at the axis of the roller;
a belt wheel cavity is arranged in the lifting plate on the left side;
a driven belt wheel is fixedly arranged in the belt wheel cavity;
a driving belt wheel is rotationally arranged on the upper side between the driven belt wheels;
a transmission belt is wound between the driving belt wheel and the driven belt wheel.

3. The sterilizing and soaking device for leather manufacturing as defined in claim 1, wherein a lifting rod is slidably arranged in the lifting cavity;
a threaded cavity with downward opening is formed in the lifting rod;
a threaded rod rotationally connected to the lower wall of the lifting cavity is in threaded connection in the threaded cavity;
a bevel gear cavity is formed in the lower side of the lifting cavity;
a driven bevel gear is fixedly arranged in the bevel gear cavity at the lower end of the bevel gear cavity.

4. The sterilizing and soaking device for leather manufacturing as defined in claim 1, wherein a lifting motor is fixedly arranged in the inner wall between the bevel gear cavities;
the left end and the right end of the lifting motor are symmetrically and electrically connected with a power shaft;
the opposite end of the power shaft extends into the bevel gear cavity and is fixedly provided with a driving bevel gear meshed with the driven bevel gear.

5. The sterilizing and soaking device for leather manufacturing as defined in claim 1, wherein a guide sliding rod which is fixedly connected to the upper end of the lifting rod is slidably arranged in the guide sliding cavity;
the relative end of the guide sliding rod is fixedly connected to the lifting plate.

6. The sterilizing and soaking device for leather manufacturing as defined in claim 1, wherein the turnover plate device comprises a turnover plate which is bilaterally symmetric and can be overturned and arranged in the discharge cavity,
a rotating shaft is fixedly arranged at the rotating center of the upper end of the turning plate;
a straight gear is fixedly arranged at the left end and the right end of the turning shaft;
a straight gear is fixedly arranged in the lifting cavity;
a fixing rod is symmetrically and fixedly arranged at the front end and the rear end of the lifting rod;
a rack which can be meshed with the straight gear is fixedly arranged at one end, far away from the lifting rod, of the fixing rod.

7. The sterilizing and soaking device for leather manufacturing as defined in claim 1, wherein the switching device comprises a power cavity which is communicated with the left wall of the lifting cavity on the left side,
and a rotating motor is fixedly arranged at the lower end of the left wall of the power cavity,
the right end of the rotating motor is in power connection with a driving straight gear,
a transmission spur gear which can be meshed with the driving spur gear is rotationally arranged at the left end of the guide sliding rod on the left side;
a transmission shaft is fixedly arranged at the axis of the transmission straight gear;
the right end of the transmission shaft is fixedly connected with the axis of the driving belt wheel;
a manual straight gear capable of being meshed with the transmission straight gear is rotationally arranged on the upper side in the power cavity;
a manual shaft is fixedly arranged at the axis of the manual straight gear;
a rocker is fixedly arranged at the left end of the manual shaft to the outside.

8. The sterilizing and soaking device for leather manufacturing as defined in claim 1, when the transmission spur gear is meshed with the rotation motor, the rotation motor provides power, and when the transmission spur gear is meshed with the manual spur gear, the rocker provides power for the rocker.
